(19) United States
(12) Patent Application Publication
(10) Pub. No.: US 2011/0203989 A1
(43) Pub. Date: Aug. 25, 2011

(54) DISC FILTER SECTOR AND SECTOR COMPONENT

(75) Inventor: Anssi Rantala, Lempaala (FI)

(73) Assignee: METSO FABRICS OY, Tampere (FI)

(21) Appl. No.: 13/125,473

(22) PCT Filed: Nov. 3, 2009
(86) PCT No.: PCT/FI2009/050884

§ 371 Date: Apr. 21, 2011

(30) Foreign Application Priority Data
Nov. 7, 2008 (FI) 20080615

(51) Int. Cl. B01D 33/23

(52) U.S. Cl. 210/483

(57) ABSTRACT

A disc filter sector and a disc filter sector component which are made of a plastic composite containing a matrix plastic and a fibre reinforcement. The fibre reinforcement used is a natural fibre, such as a wood fibre.

### BACKGROUND OF THE INVENTION

The invention relates to a sector of a disc filter used in solid-liquid filtering. The sector is a subtantially triangular hollow piece whose opposite side surfaces serve as filtering surfaces. The side surfaces are provided with several openings. A narrower end of the sector is provided with a neck part which enables the sector to be fastened to a frame of the disc filter. Further, a wider end of the sector is provided with an end part. The sides are connected by side parts.

The invention further relates to a sector component which belongs to a sector of a disc filter.

The fields of the invention are defined in closer detail in the preambles of the independent claims.

For instance in mining industry, refinement of metals, chemical industry as well as in manufacturing processes of foodstuffs and pharmaceuticals a need exists for solid-liquid filtering wherein from a mixture formed by solid matter and liquid, liquid and solid matter particles are separated. For solid-liquid filtering, mechanical filtering apparatuses having different operational principles and properties have been developed which utilize a pressure difference in separating a liquid phase and a solid matter phase. One such solid-liquid filter is a disc filter.

A disc filter comprises a tubular frame part whose outer circumference is provided with substantially triangular sector elements side by side such that the elements form a disc-like structure. An underpressure is formed inside the sector elements, and the side surfaces of the sector elements serve as filtering surfaces that are usually provided with a filtering cloth. The filtering surfaces are provided with openings along which liquid that has passed the filtering cloth is allowed to enter a sector element wherefrom, under the influence of underpressure, the liquid further flows to the frame part of the disc filter.

Nowadays the sector elements are made from a plastic material. Since during use the sectors are subjected to loads which tend to deform the sectors, a need exists in more and more applications to use sectors which are made from a plastic composite and which are provided with better strength properties than sectors made from a plastic material only. A sector made from a plastic composite consists of plastic reinforced with fibres. Typically, fibre-glass is used as a reinforcing fibre. A problem with the existing fibre-reinforced sectors is the matter of destroying them after they have been removed from use. It is difficult to recycle and recover the plastic material of used sectors since during a filtering process various impurities, such as ore, become stuck to the sector from slurry and are then passed along with the plastic material to a recycled product, impairing its properties. In addition, the impurities contained in recycled plastic wear down the process devices and moulds.

### BRIEF DESCRIPTION OF THE INVENTION

An object of the present invention is to provide a novel and improved disc filter sector and sector component.

A sector according to the invention is characterized in that the plastic material used in the sector is fibre-reinforced with natural fibres.

A sector component according to the invention is characterized in that the material of the sector component is a plastic composite wherein a matrix plastic is fibre-reinforced with natural fibres.

An idea of the invention is that the entire sector or at least some sector component belonging thereto is formed from a plastic composite wherein instead of synthetic fibres, the matrix plastic is fibre-reinforced with natural fibres.

An advantage of the invention is that sectors and sector components removed from use may be destroyed after use by crushing them and by burning them in a normal thermal boiler. Natural reinforcing fibres burn during combustion and leave no combustion residues that are difficult to destroy. When burned, natural fibres turn to ashes, and their combustion gases are non-toxic. A further advantage is that natural fibres are a renewable natural resource, so it is ecological to use them. This gives a product a positive image.

An idea of an embodiment is that the fibre reinforcement is a wood fibre. Wood fibres are extremely thin elongated threads. Herein, a composite reinforced with wood fibres does not refer to a conventional wood-plastic composite (WPC) wherein wood shavings or wood chips having a large particle size have been mixed with plastic so that the wood material serves as a filler. In the solution according to this embodiment, rather than as a filler, the wood fibres serve as a reinforcing material. The wood fibres enable a good strength, a good dimensional accuracy and a small thermal contraction to be achieved.

An idea of an embodiment is that the fibre reinforcement is a wood fibre processed from coniferous wood.

An idea of an embodiment is that the fibre reinforcement is a wood fibre whose length is less than 2 mm, typically 1 to 1,5 mm.

An idea of an embodiment is that the fibre reinforcement is a wood fibre processed mechanically from wood. The length of the wood fibres may be less than 1 mm.

An idea of an embodiment is that the fibre reinforcement is a wood fibre processed chemically from wood. The length of the wood fibres may be less than 2 mm.

An idea of an embodiment is that the natural fibre reinforcement is a thin thread whose length is multiple with respect to its diameter. The diameter of the fibre reinforcement may be 10 to 50 μm. If, for example, the length of the reinforcing fibre is 1 mm and the diameter is 10 μm, the ratio of length to diameter is one hundred fold.

An idea of an embodiment is that the fibre reinforcement is a flax fibre.

An idea of an embodiment is that the fibre reinforcement is hemp.

An idea of an embodiment is that the fibre reinforcement is a sisal fibre.

An idea of an embodiment is that the proportion of the fibre reinforcement in the plastic composite is 5 to 60 percent by weight, preferably 20 to 40 percent by weight. The tests conducted showed that a proportion of 25 percent by weight of natural fibre reinforcement was particularly advantageous.

An idea of an embodiment is that the sector or the sector component is fibre-reinforced only by one or more natural fibre reinforcements.

An idea of an embodiment is that the matrix plastic is polypropylene (PP). Polypropylene is a thermoplastic plastic with a good mechanical and chemical strength, so it is highly suitable for use in disc filtering circumstances. In addition, polypropylene is an environmentally friendly plastic which may be burned without any problems as an energy fraction.

An idea of an embodiment is that the sector is formed by injection moulding. Injection moulding is a quick and efficient manufacturing method which enables formation of dimensionally accurate pieces. The use of a natural fibre reinforcement does not require any substantial changes to be made to a normal injection moulding process and injection moulding devices. It has been noticed that when natural fibres are used, injection moulding machines and tools wear down less than when using synthetic fibre reinforcements.

An idea of an embodiment is that the sector has been assembled from two or more sector components that have been manufactured by injection moulding. A sector component comprises connecting members, such as connecting surfaces, snap-on connectors, screw fastening points or the like, for fastening it to other components or to the base frame of the sector.

An idea of an embodiment is that the sector or the sector component is manufactured by rotational moulding.

An idea of an embodiment is that the sector or the sector component has been manufactured by thermoforming it from a plastic composite material reinforced with natural fibres. The plastic composite may be e.g. a plate-like material and the moulding may be carried out by means of a mould and heat.

### BRIEF DESCRIPTION OF THE FIGURES

Some embodiments of the invention are described in closer detail in the accompanying drawings, in which

FIG. 1 is a schematic side view showing a disc filter,

FIG. 2 is a schematic side view showing a sector of a disc filter,

FIG. 3 is a schematic cut-open view showing a sector formed from two halves,

FIG. 4 is a schematic cut-open side view showing a sector assembled from several sector components,

FIG. 5 shows a detail of a material of a sector or a sector component, and

FIG. 6 shows a solid-liquid filter of yet another kind, namely a drum filter, whose outer circumference is provided with replaceable filter modules manufactured from a plastic composite reinforced with natural fibres.

For the sake of clarity, the figures show some embodiments of the invention in a simplified manner. Like reference numerals identify like elements.

### DETAILED DESCRIPTION OF SOME EMBODIMENTS OF THE INVENTION

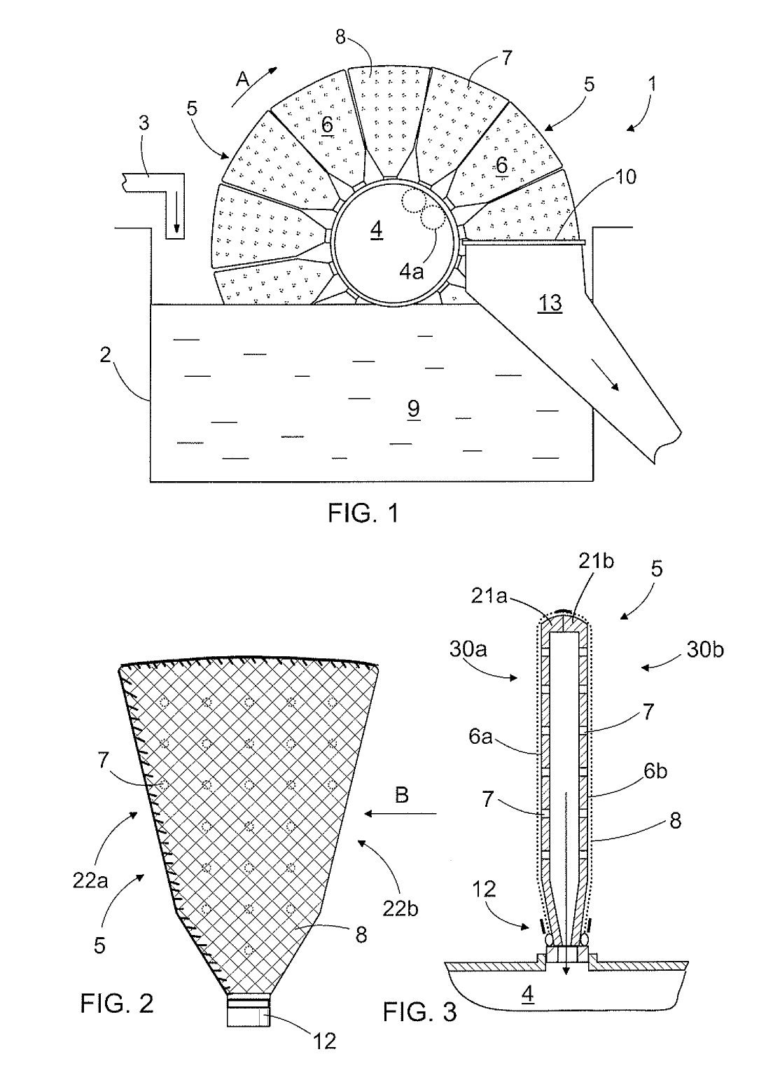

FIG. 1 shows a disc filter 1 which comprises a reservoir 2 whereto a solution formed by a solid matter and liquid is supplied for processing from a feed channel 3. It is to be noted that typically the surface of the solution contained in the reservoir 2 is lower than what is shown herein. Further, the disc filter 1 comprises a frame part 4 rotatable around a horizontal axis. The frame part 4 may be formed from one tubular piece or, alternatively, it may be formed from several tubes 4a. The outer circumference of the frame part 4 is provided with several, substantially triangular sectors 5 side by side, whereby the sectors 5 form a relatively narrow, disc-like structure around the frame part 4. One frame part 4 may comprise several such disc-like structures arranged at an axial distance from one another. Triangular side surfaces 6 of each sector 5 are provided with openings 7. Against a side surface 6, a filtering cloth 8 or the like may be arranged which may serve as a filtering layer. The frame part 4 of the disc filter is rotated around its longitudinal axis in direction

A, whereby each sector 5, each in its turn, becomes immersed in the solution 9 contained in the reservoir 2. Inside the sector 5 immersed in the solution 9, an underpressure may be formed via the frame part 4. In such a case, liquid is allowed to pass into the sector 5 through a filtering bag 8 shown in FIGS. 2 and 3 and made from a solid-liquid filtering cloth and further via the openings 7 provided in the side surface 6 of the sector. Inside the sector 5, the liquid flows influenced by the underpressure along a flow channel 11 to a neck part 12 of the sector and further via the frame part 4 away from the disc filter. The solid matter, in turn, remains on the surface of the filtering cloth 8, wherefrom it may be removed by means of doctor blades 10 or pressure medium sprays into a discharge shaft 13 prior to a next filtering cycle. Alternatively, the cloth is distended by pressure for removing a solid matter cake.

FIGS. 2 and 3 show that a filtering bag 8 or another replaceable filtering element may be arranged on top of the sector 5. On the other hand, the openings provided in the side surfaces 6 of the sector may be dimensioned such that no separate filtering element is necessary but the sides of the sector serve as the filtering elements.

FIG. 3 shows that the sector 5 may be formed from one uniform piece or it may be formed from two halves fastened to one another. Such side elements 30a, 30b comprise side surfaces 6 as well as sections of the sides, end 21a, 21b and the neck part 12. The side elements may be identical, which makes the manufacturing process easier.

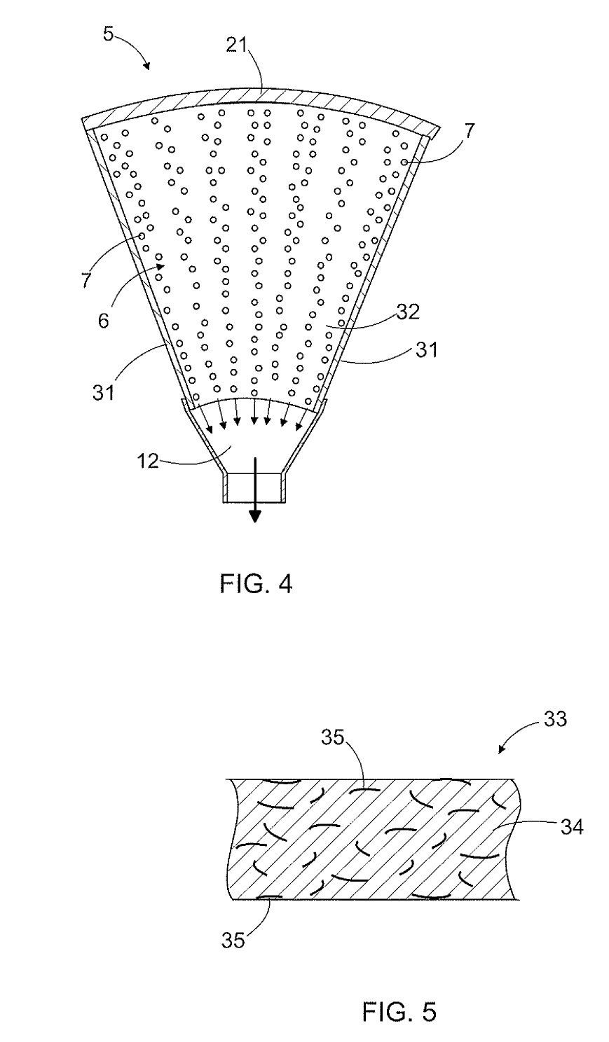

FIG. 4 shows that the sector 5 may be assembled from several separately manufactured components, such as two side plates 31, end piece 21, neck part 12 and two side pieces 32.

FIG. 5 shows a cross-section of a wall 33 of a sector or a sector component, being made from a plastic composite and comprising a matrix plastic 34 and natural fibre reinforcements 35. The fibre reinforcements 35 have in advance been mixed with the plastic material to be cast, whereby they become evenly spread in the product being formed during casting. The reinforcing fibres 35 may be extremely thin threads, which enables even extremely thin walls and ribs to be made.

Preferably, the sector and the sector component are reinforced only by one or more natural fibre reinforcements, so they are completely free from synthetic fibre reinforcements, such as glass, kevlar, aramid, and carbon fibre.

The sector and its components may be manufactured by casting. Injection moulding is suitable for large series. Rotational casting and other mould casting techniques may also be utilized.

The sector and its components may also be manufactured by thermoforming them from a preform, such as a plate, made from a composite plastic material.

The side surfaces of the sector may be wavelike; compared to planar side surfaces, this enables a larger filtering surface area to be achieved. Further, the sector may comprise one or more flow channels.

It is further to be mentioned that yet another advantage of a sector or a sector component reinforced with natural fibres is that the natural fibres provided on the outer surface of the sector are gentler than e.g. fibre-glass fibres, which makes it possible to reduce the stress exerted on the filtering bag and wearing it down. In such a case, the filtering bag may last longer in use. Further, the specific weight of natural fibres is typically lower than the weight of synthetic fibres, so it is possible to make the sector lighter by using natural fibres. This makes the sectors easier to replace and handle otherwise.

A further embodiment may also be that the sector comprises a base frame to which replaceable side plates provided with openings may be fastened. The side plates may be wearing pieces and they may be made from a natural fibre reinforced plastic composite. In such a case, it is easy to destroy the side plates after use e.g. by burning. The base frame may be made from a plastic composite, metal or some other suitable material.

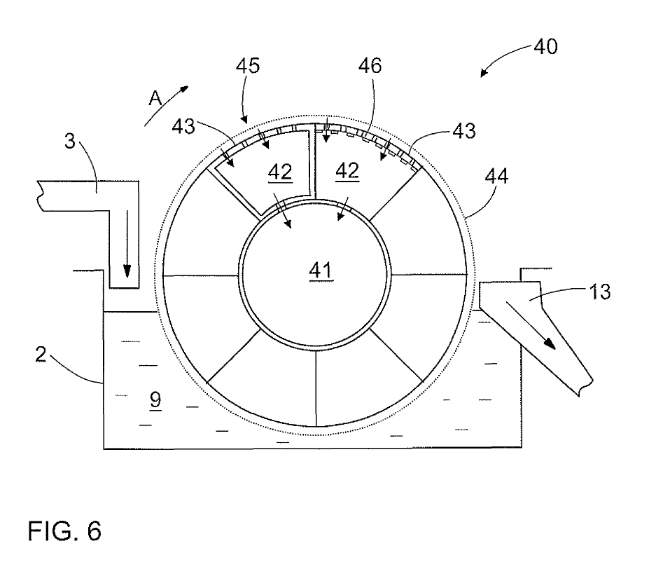

FIG. 6 shows a drum filter 40 whose structure is slightly different from that of the disc filter shown above. On the outer circumference of a frame part 41, the drum filter 40 is provided with hollow axially-directed spaces 42 whose outer circumference serves as a filtering surface 43. The filtering surface 43 is provided with several openings wherefrom the filtered liquid, under the influence of underpressure, is allowed to flow into the drum filter. The outer circumference of the drum filter may be provided with a filtering cloth 44. The drum filter 40 is rotated in direction A around its longitudinal axis in a reservoir 2 containing a solution 9 to be processed. A solid matter cake formed on the surface of the filtering cloth 44 may be detached and led to a discharge shaft 13. The outer circumference of the drum filter 40 may be provided with several replaceable filtering modules 45 which comprise a filtering surface 43 and a structure to support it. Alternatively, the outer circumference of the drum filter 40 may be provided with a fixed support structure to which replaceable filtering surface modules 46 may be attached which may be provided with openings or lattice-like structures. The openings may be substantially rectangular and ribs or narrow intermediate walls are provided therebetween. Further, the side of the interior surface of the module 46 may be provided with projection-like sections, such as pins or bosses, which enable a gap to be formed between the module 46 and the support structure such that liquid is allowed to flow therethrough. The aforementioned modules 45 and 46 belonging to the drum filter may be made from a plastic material reinforced with natural fibres, in which case they may be destroyed by burning after having been removed from use. The modules 45 and 46 may be made e.g. by injection moulding them from a plastic composite comprising polypropylene and wood fibre. The discussion set forth above in this application and relating to material-technical matters, i.e. the features of a plastic composite reinforced with natural fibres, different material applications and advantages thereof also applies to different drum filter modules.

In some cases, the features disclosed in this application may be used as such, irrespective of other features. On the other hand, when necessary, the features disclosed in this application may be combined in order to form different combinations.

The drawings and the related description are only intended to illustrate the idea of the invention. The details of the invention may vary within the scope of the claims.

1. A disc filter sector comprising: mutually opposite side surfaces of a substantially triangular shape, comprising a wider outer edge and a narrower inner edge,
sides connecting the side surfaces in a radial direction of the sector,
an end in the outer edge of the sector,
a neck part in the inner edge of the sector, the neck part being connectable to a frame part of the disc filter,
several openings in both side surfaces,
the sector being made from a plastic composite comprising at least one matrix plastic material and at least one fibre reinforcement,
and the plastic material used in the sector is fibre-reinforced with natural fibres.

2. A sector as claimed in claim 1, wherein
the fibre reinforcement is a wood fibre.

3. A sector as claimed in claim 1, wherein
the fibre reinforcement is a relatively thin elongated thread whose length is multiple with respect to its diameter.

4. A sector as claimed in claim 1, wherein
the proportion of the fibre reinforcement in the plastic composite is 5 to 60 percent by weight.

5. A sector as claimed in claim 1, wherein
the matrix plastic is polypropylene.

6. A sector as claimed in claim 1, wherein
the sector formed from two interconnected halves made by injection moulding.

7. A disc filter sector component comprising connecting members for fastening to a sector and being made from a plastic composite, and
the material of the sector component is a plastic composite wherein a matrix plastic is reinforced with natural fibres.

8. A sector component as claimed in claim 7, wherein.
the sector component is a side element comprising one side surface and part of an end, sides as well as neck part of a sector being formed, whereby two interconnected side elements are arranged to form the sector.

9. A sector component as claimed in claim 7, wherein
the sector component is a neck part which is fastenable to a base structure of the sector and by means of which the sector is arranged to be connected to a frame of the disc filter.

10. A sector component as claimed in claim 7, wherein
the sector component is one of the following separate pieces: a side plate of a sector; an end piece of a sector; a side piece of a sector.
